(19) United States
(12) Patent Application Publication
(10) Pub. No.: US 2015/0163592 A1
(43) Pub. Date: Jun. 11, 2015

(54) SYSTEMS AND METHODS FOR BANDLIMITING ANTI-NOISE IN PERSONAL AUDIO DEVICES HAVING ADAPTIVE NOISE CANCELLATION

(71) Applicant: Cirrus Logic, Inc., Austin, TX (US)

(72) Inventor: Jeffrey D. Alderson, Austin, TX (US)

(73) Assignee: Cirrus Logic, Inc., Austin, TX (US)

(21) Appl. No.: 14/101,955

(22) Filed: Dec. 10, 2013

(51) Int. Cl. H04R 3/00

(52) U.S. Cl. CPC H04R 3/002; H04R 2410/03

(57) ABSTRACT

A method may include adaptively generating an anti-noise signal from filtering a reference microphone signal with an adaptive filter in conformity with an error microphone signal and the reference microphone signal. The method may also include adjusting the response of the adaptive filter by combining injected noise with the reference microphone signal and receiving the injected noise by a copy of the adaptive filter so that the response of the copy is controlled by the adaptive filter adapting to cancel a combination of the ambient audio sounds and the injected noise and controlling the response of the adaptive filter with the coefficients adapted in the copy, whereby the injected noise is not present in the anti-noise signal and wherein each of a sample rate of the copy and a rate of adapting of the adaptive filter is significantly less than a sample rate of the adaptive filter.

### FIELD OF DISCLOSURE

The present disclosure relates in general to adaptive noise cancellation in connection with an acoustic transducer, and more particularly, to bandlimiting anti-noise in personal audio devices having adaptive noise cancellation.

### BACKGROUND

Personal audio devices, such as mobile/cellular telephones, cordless telephones, and other consumer audio devices, such as MP3 players and headphones or earbuds, are in widespread use. Performance of such devices with respect to intelligibility can be improved by providing noise canceling using a microphone to measure ambient acoustic events and then using signal processing to insert an anti-noise signal into the output of the device to cancel the ambient acoustic events. Because the acoustic environment around personal audio devices such as wireless telephones can change dramatically, depending on the sources of noise that are present and the position of the device itself, it is desirable to adapt the noise canceling to take into account such environmental changes. However, adaptive noise canceling circuits can be complex, consume additional power and can generate undesirable results under certain circumstances.

Therefore, it would be desirable to provide a personal audio device, including a wireless telephone, that provides noise cancellation in a variable acoustic environment.

### SUMMARY

In accordance with the teachings of the present disclosure, the disadvantages and problems associated with improving audio performance of a personal audio device may be reduced or eliminated.

In accordance with embodiments of the present disclosure, an integrated circuit for implementing at least a portion of a personal audio device may include an output, a reference microphone input, an error microphone input, and a processing circuit. The output may provide a signal to a transducer including both source audio for playback to a listener and an anti-noise signal for countering the effects of ambient audio sounds in an acoustic output of the transducer. The reference microphone input may receive a reference microphone signal indicative of the ambient audio sounds. The error microphone input may receive an error microphone signal indicative of the output of the transducer and the ambient audio sounds at the transducer. The processing circuit may implement an adaptive filter having a response that generates the anti-noise signal from the reference microphone signal to reduce the presence of the ambient audio sounds heard by the listener. The processing circuit may shape the response of the adaptive filter in conformity with the error microphone signal and the reference microphone signal by adapting the response of the adaptive filter to minimize the ambient audio sounds at the error microphone. The response of the adaptive filter may be further adjusted independent of the adapting by combining injected noise with the reference microphone signal and the processing circuit further implements a copy of the adaptive filter to receive the injected noise so that the response of the copy of the adaptive filter is controlled by the adaptive filter adapting to cancel a combination of the ambient audio sounds and the injected noise. The processing circuit may further control the response of the adaptive filter with the coefficients adapted in the copy of the adaptive filter, whereby the injected noise is not present in the anti-noise signal. Each of a sample rate of the copy of the adaptive filter and a rate of adapting of the adaptive filter may be significantly less than a sample rate of the adaptive filter.

In accordance with these and other embodiments of the present disclosure, an integrated circuit for implementing at least a portion of a personal audio device may include an output, a reference microphone input, an error microphone input, and a processing circuit. The output may provide a signal to a transducer including both source audio for playback to a listener and an anti-noise signal for countering the effects of ambient audio sounds in an acoustic output of the transducer. The reference microphone input may receive a reference microphone signal indicative of the ambient audio sounds. The error microphone input may receive an error microphone signal indicative of the output of the transducer and the ambient audio sounds at the transducer. The processing circuit may implement an adaptive filter having a response that generates the anti-noise signal from the reference microphone signal to reduce the presence of the ambient audio sounds heard by the listener. The processing circuit may shape the response of the adaptive filter in conformity with the error microphone signal and the reference microphone signal by adapting the response of the adaptive filter to minimize the ambient audio sounds at the error microphone. The response of the adaptive filter may be further adjusted independent of the adapting by combining injected noise with the reference microphone signal, and the processing circuit may further implement a copy of the adaptive filter to receive the injected noise so that the response of the copy of the adaptive filter is controlled by the adaptive filter adapting to cancel a combination of the ambient audio sounds and the injected noise. The processing circuit may further control the response of the adaptive filter with the coefficients adapted in the copy of the adaptive filter, whereby the injected noise is not present in the anti-noise signal. The injected noise may be provided by a periodic shaped noise signal stored in a buffer, such that the copy of the adaptive filter generates a periodic error noise signal from the periodic shaped noise signal, further such that the processing circuit shapes the response of the adaptive filter in conformity with a combination of the error microphone signal and the periodic error noise signal, and a combination of the periodic shaped noise signal and the reference microphone signal.

In accordance with these and other embodiments of the present disclosure, a method may include receiving a reference microphone signal indicative of ambient audio sounds at the acoustic output of a transducer and receiving an error microphone signal indicative of an acoustic output of a transducer and the ambient audio sounds at the acoustic output of the transducer. The method may also include generating an anti-noise signal from filtering the reference microphone signal with an adaptive filter to reduce the presence of the ambient audio sounds heard by the listener and shaping the response of the adaptive filter in conformity with the error microphone signal and the reference microphone signal by adapting the response of the adaptive filter to minimize the ambient audio sounds at the error microphone. The method may also include further adjusting the response of the adaptive filter by combining injected noise with the reference microphone signal and receiving the injected noise by a copy of the adaptive filter so that the response of the copy of the adaptive filter is controlled by the adaptive filter adapting to cancel a combination of the ambient audio sounds and the injected noise. The method may also include controlling the response of the adaptive filter with the coefficients adapted in the copy of the adaptive filter, whereby the injected noise is not present in the anti-noise signal and wherein each of a sample rate of the copy of the adaptive filter and a rate of adapting of the adaptive filter is significantly less than a sample rate of the adaptive filter.

In accordance with these and other embodiments of the present disclosure, a method may include receiving a reference microphone signal indicative of ambient audio sounds at the acoustic output of a transducer and receiving an error microphone signal indicative of an acoustic output of a transducer and the ambient audio sounds at the acoustic output of the transducer. The method may also include generating an anti-noise signal from filtering the reference microphone signal with an adaptive filter to reduce the presence of the ambient audio sounds heard by the listener and further adjusting the response of the adaptive filter by combining injected noise with the reference microphone signal. The method may also include receiving the injected noise by a copy of the adaptive filter so that the response of the copy of the adaptive filter is controlled by the adaptive filter adapting to cancel a combination of the ambient audio sounds and the injected noise and controlling the response of the adaptive filter with the coefficients adapted in the copy of the adaptive filter, whereby the injected noise is not present in the anti-noise signal and is provided by a periodic shaped noise signal stored in a buffer, such that the copy of the adaptive filter generates a periodic error noise signal from the periodic shaped noise signal. The method may additionally include shaping of the response of the adaptive filter in conformity with a combination of the error microphone signal and the periodic error noise signal, and a combination of the periodic shaped noise signal and the reference microphone signal.

Technical advantages of the present disclosure may be readily apparent to one of ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1A is an illustration of an example personal audio device, in accordance with embodiments of the present disclosure;

FIG. 1B is an illustration of an example personal audio device with a headphone assembly coupled thereto, in accordance with embodiments of the present disclosure;

FIG. 2 is a block diagram of selected circuits within the personal audio device depicted in FIG. 1, in accordance with embodiments of the present disclosure;

FIG. 3A is a block diagram depicting selected signal processing circuits and functional blocks within an example active noise canceling (ANC) circuit of a coder-decoder (CODEC) integrated circuit of FIG. 2, in accordance with embodiments of the present disclosure;

FIG. 3B is a block diagram depicting selected signal processing circuits and functional blocks within another example ANC circuit of CODEC integrated circuit of FIG. 2, in accordance with embodiments of the present disclosure; and

FIG. 3C is a block diagram depicting selected signal processing circuits and functional blocks within yet another example ANC circuit of CODEC integrated circuit of FIG. 2, in accordance with embodiments of the present disclosure.

### DETAILED DESCRIPTION

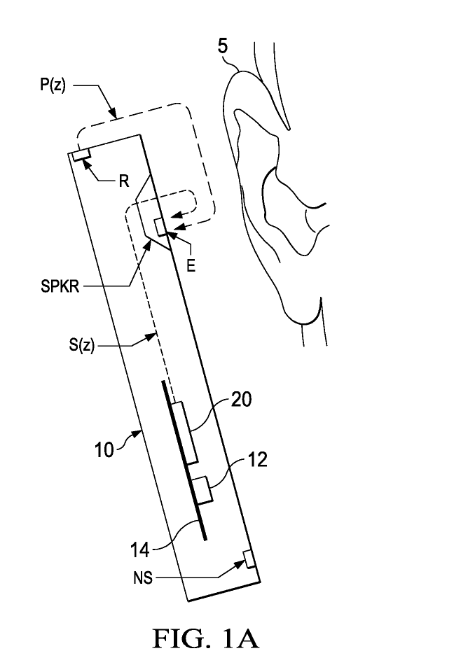

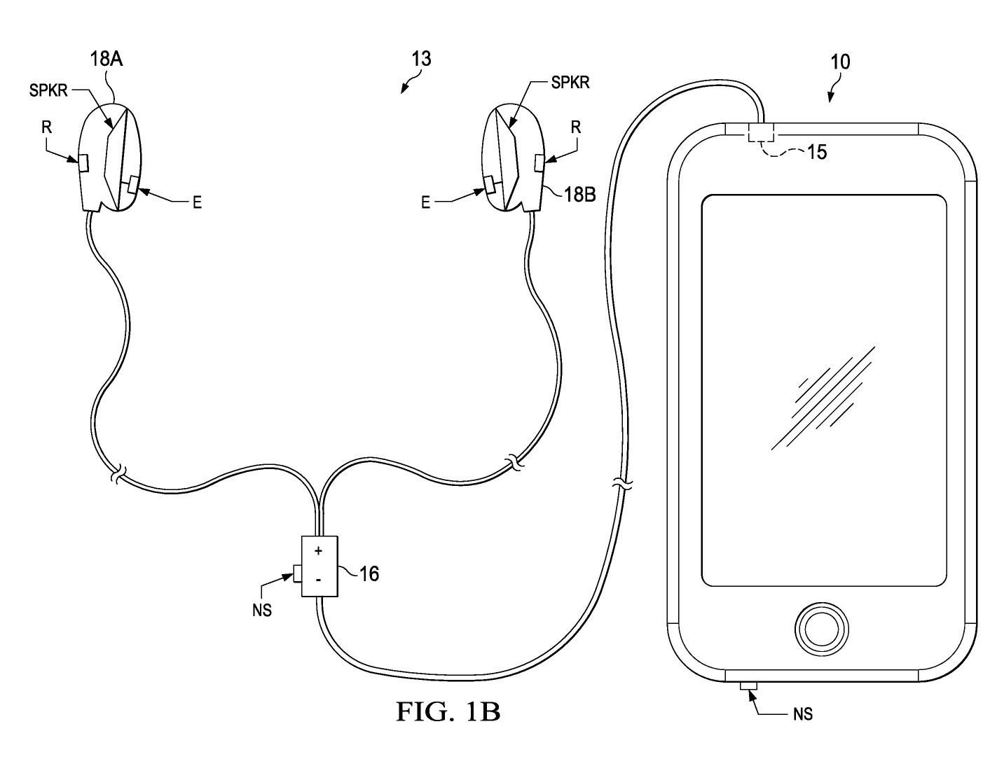

Referring now to FIG. 1A, a personal audio device 10 as illustrated in accordance with embodiments of the present disclosure is shown in proximity to a human ear 5. Personal audio device 10 is an example of a device in which techniques in accordance with embodiments of the invention may be employed, but it is understood that not all of the elements or configurations embodied in illustrated personal audio device 10, or in the circuits depicted in subsequent illustrations, are required in order to practice the invention recited in the claims. Personal audio device 10 may include a transducer such as speaker SPKR that reproduces distant speech received by personal audio device 10, along with other local audio events such as ringtones, stored audio program material, injection of near-end speech (i.e., the speech of the user of personal audio device 10) to provide a balanced conversational perception, and other audio that requires reproduction by personal audio device 10, such as sources from webpages or other network communications received by personal audio device 10 and audio indications such as a low battery indication and other system event notifications. A near-speech microphone NS may be provided to capture near-end speech, which is transmitted from personal audio device 10 to the other conversation participant(s).

Personal audio device 10 may include adaptive noise cancellation (ANC) circuits and features that inject an anti-noise signal into speaker SPKR to improve intelligibility of the distant speech and other audio reproduced by speaker SPKR. A reference microphone R may be provided for measuring the ambient acoustic environment, and may be positioned away from the typical position of a user's mouth, so that the near-end speech may be minimized in the signal produced by reference microphone R. Another microphone, error microphone E, may be provided in order to further improve the ANC operation by providing a measure of the ambient audio combined with the audio reproduced by speaker SPKR close to ear 5, when personal audio device 10 is in close proximity to ear 5. Circuit 14 within personal audio device 10 may include an audio CODEC integrated circuit (IC) 20 that receives the signals from reference microphone R, near-speech microphone NS, and error microphone E, and interfaces with other integrated circuits such as a radio-frequency (RF) integrated circuit 12 having a wireless telephone transceiver. In some embodiments of the disclosure, the circuits and techniques disclosed herein may be incorporated in a single integrated circuit that includes control circuits and other functionality for implementing the entirety of the personal audio device, such as an MP3 player-on-a-chip integrated circuit. In these and other embodiments, the circuits and techniques disclosed herein may be implemented partially or fully in software and/or firmware embodied in computer-readable media and executable by a controller or other processing device.

In general, ANC techniques of the present disclosure measure ambient acoustic events (as opposed to the output of speaker SPKR and/or the near-end speech) impinging on reference microphone R, and by also measuring the same ambient acoustic events impinging on error microphone E, ANC processing circuits of personal audio device 10 adapt an anti-noise signal generated at the output of speaker SPKR from the output of reference microphone R to have a characteristic that minimizes the amplitude of the ambient acoustic events at error microphone E. Because acoustic path P(z) extends from reference microphone R to error microphone E, ANC circuits are effectively estimating acoustic path P(z) while removing effects of an electro-acoustic path S(z) that represents the response of the audio output circuits of CODEC IC 20 and the acoustic/electric transfer function of speaker SPKR including the coupling between speaker SPKR and error microphone E in the particular acoustic environment, which may be affected by the proximity and structure of ear 5 and other physical objects and human head structures that may be in proximity to personal audio device 10, when personal audio device 10 is not firmly pressed to ear 5. While the illustrated personal audio device 10 includes a two-microphone ANC system with a third near-speech microphone NS, some aspects of the present invention may be practiced in a system that does not include separate error and reference microphones, or a wireless telephone that uses near-speech microphone NS to perform the function of the reference microphone R. Also, in personal audio devices designed only for audio playback, near-speech microphone NS will generally not be included, and the near-speech signal paths in the circuits described in further detail below may be omitted, without changing the scope of the disclosure, other than to limit the options provided for input to the microphone covering detection schemes. In addition, although only one reference microphone R is depicted in FIG. 1, the circuits and techniques herein disclosed may be adapted, without changing the scope of the disclosure, to personal audio devices including a plurality of reference microphones.

Referring now to FIG. 1B, personal audio device 10 is depicted having a headphone assembly 13 coupled to it via audio port 15. Audio port 15 may be communicatively coupled to RF integrated circuit 12 and/or CODEC IC 20, thus permitting communication between components of headphone assembly 13 and one or more of RF integrated circuit 12 and/or CODEC IC 20. As shown in FIG. 1B, headphone assembly 13 may include a combox 16, a left headphone 18A, and a right headphone 18B. As used in this disclosure, the term “headphone” broadly includes any loudspeaker and structure associated therewith that is intended to be mechanically held in place proximate to a listener's ear or ear canal, and includes without limitation earphones, earbuds, and other similar devices. As more specific non-limiting examples, “headphone,” may refer to intra-canal earphones, intra-concha earphones, supra-concha earphones, and supra-aural earphones.

Combox 16 or another portion of headphone assembly 13 may have a near-speech microphone NS to capture near-end speech in addition to or in lieu of near-speech microphone NS of personal audio device 10. In addition, each headphone 18A, 18B may include a transducer such as speaker SPKR that reproduces distant speech received by personal audio device 10, along with other local audio events such as ringtones, stored audio program material, injection of near-end speech (i.e., the speech of the user of personal audio device 10) to provide a balanced conversational perception, and other audio that requires reproduction by personal audio device 10, such as sources from webpages or other network communications received by personal audio device 10 and audio indications such as a low battery indication and other system event notifications. Each headphone 18A, 18B may include a reference microphone R for measuring the ambient acoustic environment and an error microphone E for measuring of the ambient audio combined with the audio reproduced by speaker SPKR close to a listener's ear when such headphone 18A, 18B is engaged with the listener's ear. In some embodiments, CODEC IC 20 may receive the signals from reference microphone R, near-speech microphone NS, and error microphone E of each headphone and perform adaptive noise cancellation for each headphone as described herein. In other embodiments, a CODEC IC or another circuit may be present within headphone assembly 13, communicatively coupled to reference microphone R, near-speech microphone NS, and error microphone E, and configured to perform adaptive noise cancellation as described herein.

The various microphones referenced in this disclosure, including reference microphones, error microphones, and near-speech microphones, may comprise any system, device, or apparatus configured to convert sound incident at such microphone to an electrical signal that may be processed by a controller, and may include without limitation an electrostatic microphone, a condenser microphone, an electret microphone, an analog microelectromechanical systems (MEMS) microphone, a digital MEMS microphone, a piezoelectric microphone, a piezo-ceramic microphone, or dynamic microphone.

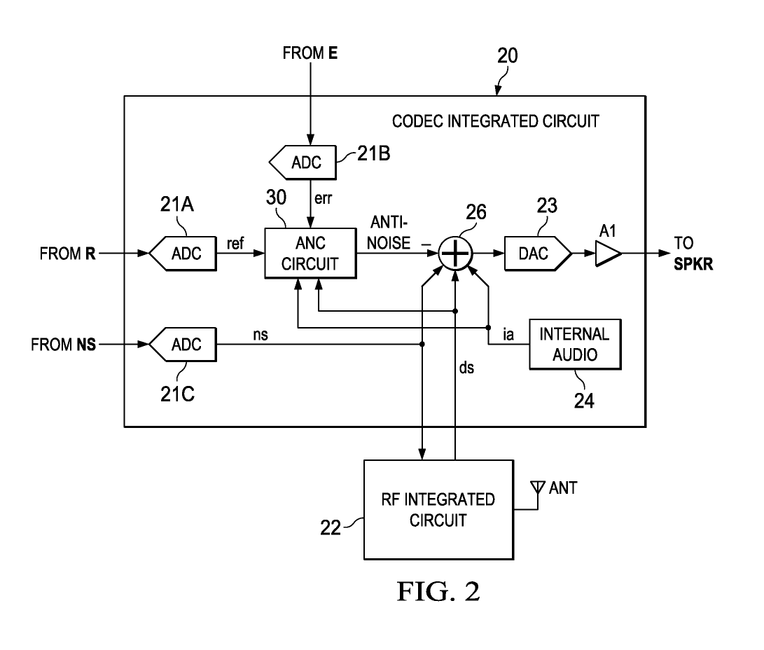

Referring now to FIG. 2, selected circuits within personal audio device 10, which in other embodiments may be placed in whole or part in other locations such as one or more headphone assemblies 13, are shown in a block diagram. CODEC IC 20 may include an analog-to-digital converter (ADC) 21A for receiving the reference microphone signal and generating a digital representation ref of the reference microphone signal, an ADC 21B for receiving the error microphone signal and generating a digital representation err of the error microphone signal, and an ADC 21C for receiving the near speech microphone signal and generating a digital representation ns of the near speech microphone signal. CODEC IC 20 may generate an output for driving speaker SPKR from an amplifier A1, which may amplify the output of a digital-to-analog converter (DAC) 23 that receives the output of a combiner 26. Combiner 26 may combine a source audio signal from audio signals is from internal audio sources 24 and/or downlink speech ds which may be received from radio frequency (RF) integrated circuit 22, the anti-noise signal generated by ANC circuit 30, which by convention has the same polarity as the noise in reference microphone signal ref and is therefore subtracted by combiner 26, and a portion of near speech microphone signal ns so that the user of personal audio device 10 may hear his or her own voice in proper relation to downlink speech ds. Near speech microphone signal ns may also be provided to RF integrated circuit 22 and may be transmitted as uplink speech to the service provider via antenna ANT.

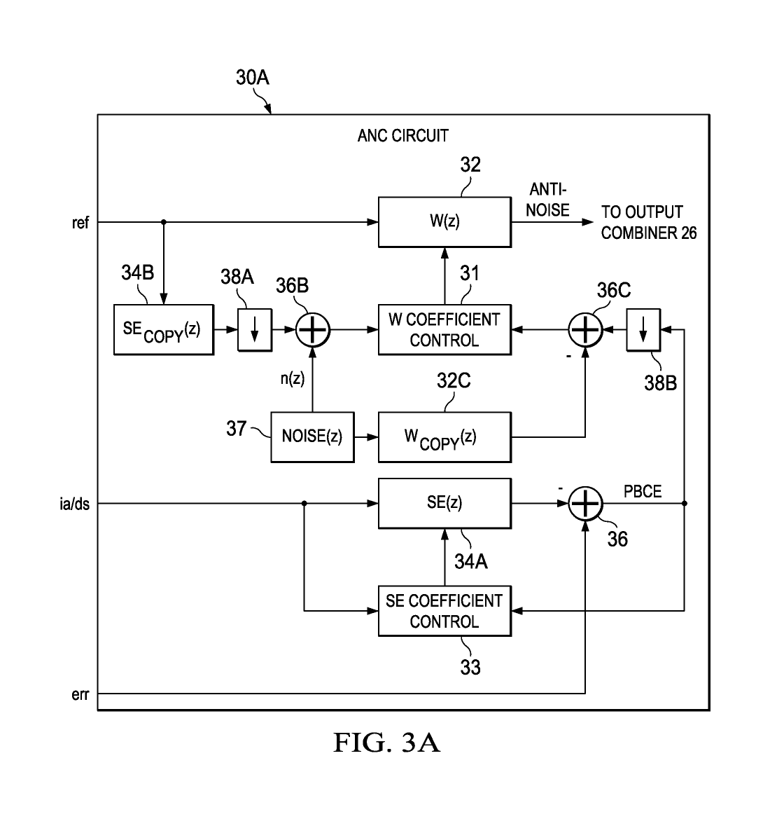

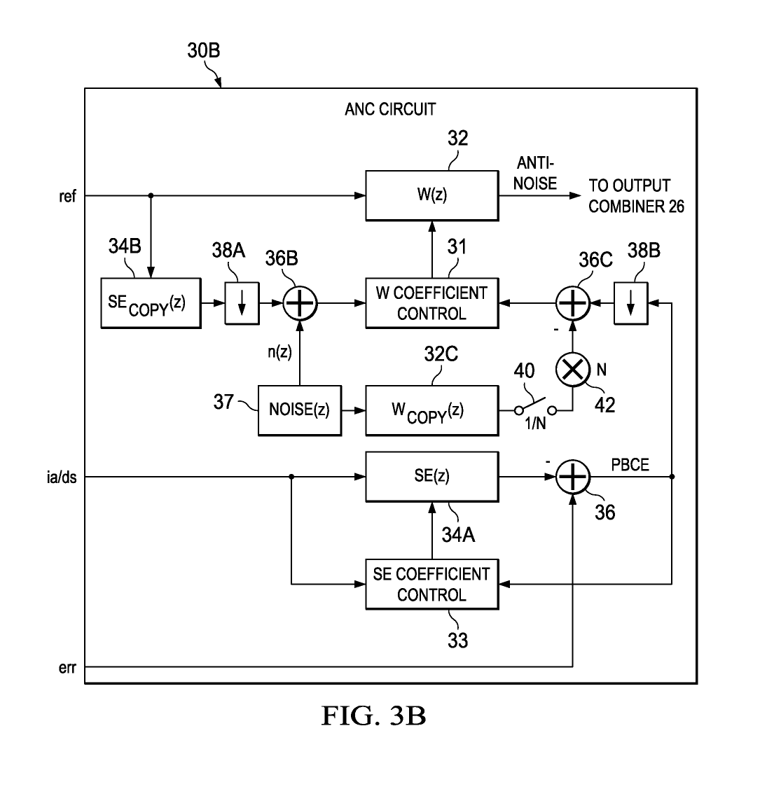

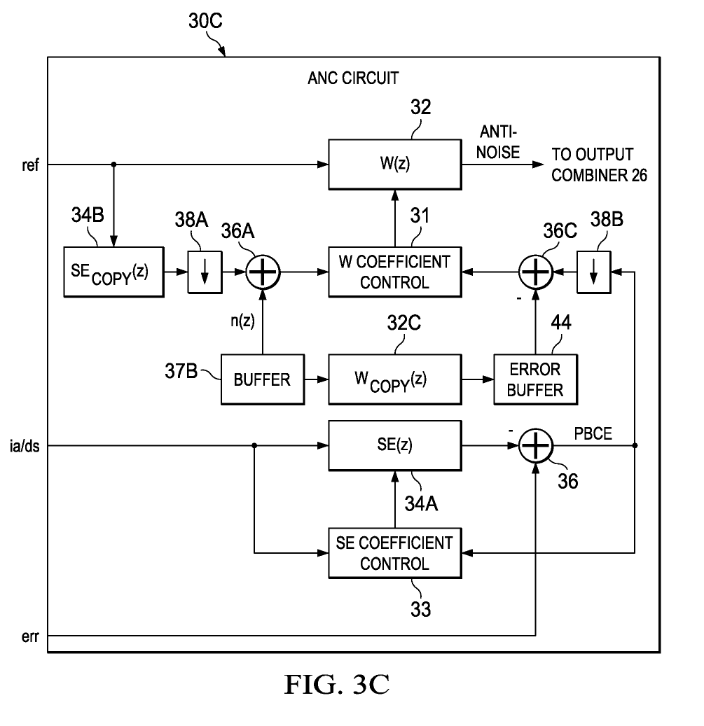

Referring now to FIG. 3A, details of ANC circuit 30A are shown in accordance with embodiments of the present disclosure. Adaptive filter 32 may receive reference microphone signal ref and under ideal circumstances, may adapt its transfer function W(z) to be P(z)/S(z) to generate the anti-noise signal, which may be provided to an output combiner that combines the anti-noise signal with the audio to be reproduced by the transducer, as exemplified by combiner 26 of FIG. 2. The coefficients of adaptive filter 32 may be controlled by a W coefficient control block 31 that uses a correlation of signals to determine the response of adaptive filter 32, which generally minimizes the error, in a least-mean squares sense, between those components of reference microphone signal ref present in error microphone signal err. The signals compared by W coefficient control block 31 may be a noise-modified reference microphone signal and a noise-modified playback corrected error. The noise-modified reference microphone signal may comprise reference microphone signal ref as shaped by a copy of an estimate of the response of path S(z) provided by filter 34B and as decimated by decimator 38A (in accordance with further description below) combined with a noise signal n(z) (also as described in further detail below). The noise-modified playback corrected error may be generated as described in greater detail below. Filter 34B may not be an adaptive filter, per se, but may have an adjustable response that is tuned to match the response of adaptive filter 34A described below, so that the response of filter 34B tracks the adapting of adaptive filter 34A.

By transforming reference microphone signal ref with a copy of the estimate of the response of path S(z), response SE_{COPY}(z) of filter 34B, and minimizing the difference between the resultant noise-modified reference microphone signal and the noise-modified playback corrected error based on error microphone signal err, adaptive filter 32 may adapt to the desired response of P(z)/S(z). The noise-modified playback corrected error signal compared to noise-modified reference microphone signal by W coefficient control block 31 may be derived from a playback corrected error (labeled as “PBCE” in FIG. 3) which may be equal to error microphone signal err combined (e.g., by combiner 36) with an inverted amount of source audio signal (e.g., downlink audio signal ds and/or internal audio signal ia), that has been processed by filter response SE(z) of filter 34A, of which response SE_{COPY}(z) is a copy. By injecting an inverted amount of source audio signal, adaptive filter 32 may be prevented from adapting to the relatively large amount of source audio signal present in error microphone signal err. However, by transforming that inverted copy of source audio signal with the estimate of the response of path S(z), the source audio that is removed from error microphone signal err to generate the playback corrected error should match the expected version of the source audio signal reproduced at error microphone signal err, because the electrical and acoustical path of S(z) is the path taken by the source audio signal to arrive at error microphone E.

To implement the above, adaptive filter 34A may have coefficients controlled by SE coefficient control block 33, which may compare the source audio signal and the playback corrected error. SE coefficient control block 33 may correlate the actual source audio signal with the components of the source audio signal that are present in error microphone signal err. Adaptive filter 34A may thereby be adapted to generate a secondary estimate signal from the source audio signal, that when subtracted from error microphone signal err to generate the playback corrected error, includes the content of error microphone signal err that is not due to the source audio signal.

As mentioned above, ANC circuit 30A may inject a noise signal n(z) using a noise generator 37 that may be supplied to a copy W_{COPY}(z) of the response W(z) of adaptive filter 32 provided by an adaptive filter 32C. A combiner 36B may add noise signal n(z) to the output of adaptive filter 34B provided to W coefficient control 31. Noise signal n(z), as shaped by filter 32C, may be subtracted from the output of combiner 36 by a combiner 36C so that noise signal n(z) is asymmetrically added to the correlation inputs to W coefficient control 31, with the result that the response W(z) of adaptive filter 32 may be biased by the completely correlated injection of noise signal n(z) to each correlation input to W coefficient control 31. Because the injected noise appears directly at the reference input to W coefficient control 31, does not appear in error microphone signal err, and only appears at the other input to W coefficient control 31 via the combining of the filtered noise at the output of filter 32C by combiner 36C, W coefficient control 31 may adapt W(z) to attenuate the frequencies present in noise signal n(z). The content of noise signal n(z) may not appear in the anti-noise signal, only in the response W(z) of adaptive filter 32 which may have amplitude decreases at the frequencies/bands in which noise signal n(z) has energy. For example, if it is desirable to decrease the response of W(z) in the vicinity of 1 kHz, noise signal n(z) can be generated to have a spectrum that has energy at 1 kHz, which will cause W coefficient control 31 to decrease the gain of adaptive filter 32 at 1 kHz in an attempt to cancel an apparent source of ambient acoustic sound due to injected noise signal n(z).

Implementation of noise signal n(z), filter 32C, and W coefficient control 31 may require significant processing resources, especially if such elements are operated at the same bandwidth as response W(z) of filter 32, and thus, addition and processing of such injected noise may contribute significantly to expense of producing a personal audio device including such an ANC circuit 30A. Such processing complexity and related expense may be reduced by implementation of a decimator 38A which may decimate reference microphone signal ref prior to its combination with noise signal n(z) by combiner 36B. Similarly, decimator 38B may decimate the playback corrected error prior to its combination with the noise signal n(z) as filtered by filter 32C. Because of the presence of decimators 38A and 38B, each of a sample rate of filter 32C and a rate of adapting of adaptive filter 32 (as controlled by W coefficient control block 31) may be significantly less (e.g., at least one order of magnitude less) than a sample rate of the adaptive filter. For example, in some embodiments filter 32 may sample at a rate of 1.5 MHz while noise generator 37, W coefficient control block 31, and filter 32C may operate at 48 kHz.

Referring now to FIG. 3B, details of another ANC circuit 30B are shown in accordance with an alternative embodiment of the present disclosure that may be used to implement ANC circuit 30 of FIG. 2. ANC circuit 30B is similar to ANC circuit 30A of FIG. 3A, so only differences between them will be described below. In ANC circuit 30B, noise signal n(z) may be continuously injected into combiner 36B, but may be only periodically added at combiner 36C. Thus, a switch 40 or other suitable component may be added such that filtered noise from filter 32C is added once every N samples. N may comprise any suitable integer number (e.g., 2 through 16). In addition, a multiplier 42 may be added to the path of the filtered noise such that the noise added each N samples is multiplied by N such that the noise-modified playback corrected error received at coefficient control block 31 is a reasonable estimate of the unfiltered noise injected into the noise-modified reference microphone signal. Accordingly, the sampling rate of filter 32C may be further significantly reduced (e.g., by a factor of 2 or more) beyond that described above in reference to ANC circuit 30A. For example, in some embodiments filter 32 may sample at a rate of 1.5 MHz, while noise generator 37 and W coefficient control block 31 may operate at 48 kHz, and filter 32C may operate at 48 kHz/N.

Referring now to FIG. 3C, details of another ANC circuit 30C are shown in accordance with an alternative embodiment of the present disclosure that may be used to implement ANC circuit 30 of FIG. 2. ANC circuit 30C is similar to ANC circuit 30A of FIG. 3A, so only differences between them will be described below. In ANC circuit 30C, instead of generating noise by noise generator 37 and filtering it, shaped noise itself may be stored in noise buffer 37B. In some embodiments, the shaped noise may be made periodic, for example, by taking a magnitude and phase response of a signal in a multiple-point fast Fourier transform and storing the inverse fast Fourier transform of the response in noise buffer 37B. Because filter 32C is, in some embodiments, a finite impulse response filter that slowly changes, the periodic shaped noise signal output by noise buffer 37B may be filtered by filter 32C, resulting in a periodic error noise signal output by filter 32C and stored in error buffer 44, assuming the response W(z) of filter 32C did not change. Such periodic error noise signal may be subtracted from the decimated playback corrected error by combiner 36C to generate the noise-modified playback corrected error applied to W coefficient control block 31. ANC circuit 30C may from time-to-time recompute the periodic error noise signal and store the recomputed periodic error noise signal in error buffer 44. For example, in some embodiments, ANC circuit 30C may recompute the periodic error noise signal and store the recomputed periodic error noise signal in error buffer 44 responsive to a substantial change in response W_{COPY}(z) of filter 32C. In these and other embodiments, ANC circuit 30C may recompute the periodic error noise signal and store the recomputed periodic error noise signal in error buffer 44 at periodic intervals less than the sample rate of the sample rate of filter 32C (e.g., every 100 milliseconds).

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An integrated circuit for implementing at least a portion of a personal audio device, comprising:
an output for providing a signal to a transducer including both source audio for playback to a listener and an anti-noise signal for countering the effects of ambient audio sounds in an acoustic output of the transducer;
a reference microphone input for receiving a reference microphone signal indicative of the ambient audio sounds;
an error microphone input for receiving an error microphone signal indicative of the acoustic output of the transducer and the ambient audio sounds at the transducer; and
a processing circuit that implements an adaptive filter having a response that generates the anti-noise signal from the reference microphone signal to reduce the presence of the ambient audio sounds heard by the listener, wherein:
the processing circuit shapes the response of the adaptive filter in conformity with the error microphone signal and the reference microphone signal by adapting the response of the adaptive filter to minimize the ambient audio sounds at the error microphone;
the response of the adaptive filter is further adjusted independent of the adapting by combining injected noise with the reference microphone signal and the processing circuit further implements a copy of the adaptive filter to receive the injected noise so that the response of the copy of the adaptive filter is controlled by the adaptive filter adapting to cancel a combination of the ambient audio sounds and the injected noise;
the processing circuit further controls the response of the adaptive filter with the coefficients adapted in the copy of the adaptive filter, whereby the injected noise is not present in the anti-noise signal; and
each of a sample rate of the copy of the adaptive filter and a rate of adapting of the adaptive filter is significantly less than a sample rate of the adaptive filter.

2. The integrated circuit of claim 1, wherein the processing circuit further implements a first decimator for decimating the reference microphone signal to the sample rate of the copy of the adaptive filter and a second decimator for decimating the error microphone signal to the sample rate of the copy of the adaptive filter, such that the processing circuit shapes the response of the adaptive filter in conformity with the decimated error microphone signal and the decimated reference microphone signal.

3. The integrated circuit of claim 1, wherein the sample rate of the copy of the adaptive filter is significantly less than the rate of adapting of the adaptive filter.

4. The integrated circuit of claim 3, wherein the processing circuit shapes the response of the adaptive filter in conformity with a first signal combining the reference microphone signal with the injected noise and a second signal comprising the error microphone signal combined with a periodic sample of the injected noise filtered by the copy of the adaptive filter.

5. The integrated circuit of claim 1, wherein the response of the adaptive filter is reduced in frequency regions in a frequency range of the injected noise.

6. An integrated circuit for implementing at least a portion of a personal audio device, comprising:
an output for providing a signal to a transducer including both source audio for playback to a listener and an anti-noise signal for countering the effects of ambient audio sounds in an acoustic output of the transducer;
a reference microphone input for receiving a reference microphone signal indicative of the ambient audio sounds;
an error microphone input for receiving an error microphone signal indicative of the acoustic output of the transducer and the ambient audio sounds at the transducer; and
a processing circuit that implements an adaptive filter having a response that generates the anti-noise signal from the reference microphone signal to reduce the presence of the ambient audio sounds heard by the listener, wherein:
the processing circuit shapes the response of the adaptive filter in conformity with the error microphone signal and the reference microphone signal by adapting the response of the adaptive filter to minimize the ambient audio sounds at the error microphone;
the response of the adaptive filter is further adjusted independent of the adapting by combining injected noise with the reference microphone signal and the processing circuit further implements a copy of the adaptive filter to receive the injected noise so that the response of the copy of the adaptive filter is controlled by the adaptive filter adapting to cancel a combination of the ambient audio sounds and the injected noise;
the processing circuit further controls the response of the adaptive filter with the coefficients adapted in the copy of the adaptive filter, whereby the injected noise is not present in the anti-noise signal; and
the injected noise is provided by a periodic shaped noise signal stored in a buffer, such that the copy of the adaptive filter generates a periodic error noise signal from the periodic shaped noise signal, further such that the processing circuit shapes the response of the adaptive filter in conformity with a combination of the error microphone signal and the periodic error noise signal, and a combination of the periodic shaped noise signal and the reference microphone signal.

7. The integrated circuit of claim 6, wherein the processing circuit stores the periodic error noise signal in a second buffer, such that the processing circuit shapes the response of the adaptive filter in conformity with a combination of the error microphone signal, the periodic error noise signal stored in the buffer, and a combination of the periodic shaped noise signal and the reference microphone signal.

8. The integrated circuit of claim 7, wherein the processing circuit updates the second buffer with the periodic error noise signal responsive to a substantial change in the response of the adaptive filter.

9. The integrated circuit of claim 7, wherein the processing circuit updates the second buffer at periodic intervals, wherein the frequency of the periodic intervals is significantly less than a sample rate of the copy of the adaptive filter.

10. A method comprising:
receiving a reference microphone signal indicative of ambient audio sounds at the acoustic output of a transducer;
receiving an error microphone signal indicative of an acoustic output of a transducer and the ambient audio sounds at the acoustic output of the transducer;
generating an anti-noise signal from filtering the reference microphone signal with an adaptive filter to reduce the presence of the ambient audio sounds heard by a listener and shaping a response of the adaptive filter in conformity with the error microphone signal and the reference microphone signal by adapting the response of the adaptive filter to minimize the ambient audio sounds at the error microphone;
further adjusting the response of the adaptive filter by combining injected noise with the reference microphone signal;
receiving the injected noise by a copy of the adaptive filter so that the response of the copy of the adaptive filter is controlled by the adaptive filter adapting to cancel a combination of the ambient audio sounds and the injected noise; and
controlling the response of the adaptive filter with the coefficients adapted in the copy of the adaptive filter, whereby the injected noise is not present in the anti-noise signal;
wherein each of a sample rate of the copy of the adaptive filter and a rate of adapting of the adaptive filter is significantly less than a sample rate of the adaptive filter.

11. The method of claim 10, further comprising
decimating the reference microphone signal to the sample rate of the copy of the adaptive filter; and
decimating the error microphone signal to the sample rate of the copy of the adaptive filter, such that the processing circuit shapes the response of the adaptive filter in conformity with the decimated error microphone signal and the decimated reference microphone signal.

12. The method of claim 10, wherein the sample rate of the copy of the adaptive filter is significantly less than the rate of adapting of the adaptive filter.

13. The method of claim 12, wherein shaping the response of the adaptive filter comprises shaping the response of the adaptive filter in conformity with a first signal combining the reference microphone signal with the injected noise and a second signal comprising the error microphone signal combined with a periodic sample of the injected noise filtered by the copy of the adaptive filter.

14. The method of claim 10, wherein the response of the adaptive filter is reduced in frequency regions in a frequency range of the injected noise.

15. A method comprising:
receiving a reference microphone signal indicative of ambient audio sounds at an acoustic output of a transducer;
receiving an error microphone signal indicative of an acoustic output of a transducer and the ambient audio sounds at the acoustic output of the transducer;
generating an anti-noise signal from filtering the reference microphone signal with an adaptive filter to reduce the presence of the ambient audio sounds heard by a listener;
further adjusting a response of the adaptive filter by combining injected noise with the reference microphone signal;
receiving the injected noise by a copy of the adaptive filter so that the response of the copy of the adaptive filter is controlled by the adaptive filter adapting to cancel a combination of the ambient audio sounds and the injected noise;
controlling the response of the adaptive filter with coefficients adapted in the copy of the adaptive filter, whereby the injected noise is not present in the anti-noise signal and is provided by a periodic shaped noise signal stored in a buffer, such that the copy of the adaptive filter generates a periodic error noise signal from the periodic shaped noise signal; and
shaping of the response of the adaptive filter in conformity with a combination of the error microphone signal and the periodic error noise signal, and a combination of the periodic shaped noise signal and the reference microphone signal.

16. The method of claim 15, further comprising storing the periodic error noise signal in a second buffer, such that the response of the adaptive filter is shaped in conformity with a combination of the error microphone signal, the periodic error noise signal stored in the buffer, and a combination of the periodic shaped noise signal and the reference microphone signal.

17. The method of claim 16, further comprising updating the second buffer with the periodic error noise signal responsive to a substantial change in the response of the adaptive filter.

18. The method of claim 16, further comprising updating the second buffer at periodic intervals, wherein the frequency of the periodic intervals is significantly less than a sample rate of the copy of the adaptive filter.
